(19) United States
(12) Patent Application Publication
(10) Pub. No.: US 2026/0193430 A1
(43) Pub. Date: Jul. 9, 2026

(54) WHITE, HEAT SHRINK FILM AND A PROCESS OF ITS MANUFACTURING

(71) Applicant: GARWARE HI-TECH FILMS LIMITED, Mumbai (IN)

(72) Inventors: Monika Shashikant GARWARE, Mumbai, Maharashtra (IN); SARITA GARWARE RAMSAY, Mumbai, Maharashtra (IN); SONJA SHASHIKANT GARWARE, Mumbai, Maharashtra (IN)

(73) Assignee: GARWARE HI-TECH FILMS LIMITED, Mumbai (IN)

(21) Appl. No.: 19/134,135

(22) PCT Filed: Nov. 17, 2023
(86) PCT No.: PCT/IB2023/061634

§ 371 Date: May 29, 2025

(30) Foreign Application Priority Data
Aug. 9, 2023 (IN) 202321053422

(51) Int. Cl. C08J 5/18; C08K 3/013; C08K 3/22; C08K 3/26; C08K 3/30; C08K 5/00; C08K 5/11; C08K 5/12; C08K 5/353; C08K 5/41; C08K 5/45; C08K 5/526

(52) U.S. Cl. CPC C08J 5/18; C08K 3/013; C08K 3/22; C08K 3/2279; C08K 3/26; C08K 3/30; C08K 5/0041; C08K 5/005; C08K 5/11; C08K 5/12; C08K 5/353; C08K 5/41; C08K 5/45; C08K 5/526; C08J 2367/03; C08K 2003/2241; C08K 2003/265; C08K 2003/3045; C08K 2201/015

(57) ABSTRACT

The present disclosure relates to a white, heat shrink film and a process for its manufacturing. The white, heat shrink film is a product of a co-polyester, a dye, an optical brightener, an antioxidant, at least one whitening additive and at least one pinning additive. The white, heat shrink film of the present disclosure is cost-effective, protects the photosensitive contents/material inside the container, enhances shelf life of the contents/material inside the container and blocks UV light. The process of the present disclosure is simple, economic and eliminates printing step of white ink printing and thereby eliminates the solvent pollution.

### FIELD

The present disclosure relates to a white, heat shrink film and a process of its manufacturing.

### Definitions

As used in the present disclosure, the following terms are generally intended to have the meaning as set forth below, except to the extent that the context in which they are used indicate otherwise.

Heat shrink film: The term “heat shrink film” refers to a film that is made of a polymeric material and the film gets shrunk upon application of heat and gets adhered to the surface on which it is applied.

Electrostatic pinning: The term “electrostatic pinning” refers to a technology that is used to improve the contact of an extruded resin onto a casting wheel during the process of producing films.

Orientation: The term “orientation” refers to a process of stretching of the mono film wherein the alignment of polymer chains in the mono film is in particular direction.

Mono-orientation: The term “mono-orientation” refers to a process of stretching of the mono film wherein the mono film is stretched in a single direction. Such film is also known as mono-axially oriented film.

Main direction orientation: The term “main direction orientation” refers to a process of stretching of the film wherein the film is heated to a temperature slightly below its melting point and oriented/stretched in the required direction of stretching i.e. along the length of the film direction.

Transverse direction orientation: The term “transverse direction orientation” refers to a process of stretching of the film wherein the film is heated to a temperature slightly below its melting point and oriented/stretched in the transverse direction i.e. along the width of the film direction.

Underwater granulator: The term “Underwater granulator” refers to an equipment, wherein polymer strands are cooled under water spray and cut it into required sizes.

Cast Film: The term “Cast film” refers to the film that is obtained by extruding the molten polymer onto a chill roll.

Mono Film: The term “Mono Film” refers to the film that is obtained by passing through machine direction orientation (MDO) unit.

### BACKGROUND

The background information herein below relates to the present disclosure but is not necessarily prior art.

Generally, a heat shrink film has properties such as shrinkability and shrinkage stress due to which the heat shrink film is widely used for various purposes such as covering, binding or casing of vessels such as plastic bottles, glass bottles and various rod-shaped molded parts such as pipes, rods and woods. Further, a wide usage of the heat shrink film is seen for multi-packaging of products such as boxes, bottles, sheets, and the like. Therefore, the heat shrink film plays a vital role in providing labeling, protecting the contents and improving the product value. Conventionally used heat shrink films are of transparent type and are further required to be printed with white ink to make the film opaque to the light to enhance the shelf life of contents inside the container. The printing of the film with the white ink is an additional operation in the process of manufacturing the heat shrink label/film. Other additional operation such as seaming of the film is also required. Hence, the conventional manufacturing of the heat shrink film is accountable for solvent pollution and energy consumption. Further, conventional heat shrink films do not provide an efficient solution for the problems.

There is, therefore, felt a need to develop a white, heat shrink film that mitigates the drawbacks mentioned herein above or at least provides a useful alternative.

### OBJECTS

Some of the objects of the present disclosure, which at least one embodiment herein satisfies, are as follows:

It is an object of the present disclosure to ameliorate one or more problems of the background or to at least provide a useful alternative.

An object of the present disclosure is to provide a white, heat shrink film.

Another object of the present disclosure is to provide a white, heat shrink film that enhances the shelf life of photosensitive contents in a container.

Still another object of the present disclosure is to provide a white, heat shrink film having enhanced aesthetic look and storage life.

Yet another object of the present disclosure is to provide a white, heat shrink film having good opacity that blocks UV light.

Still another object of the present disclosure is to provide a simple and energy saving process for the preparation of a white, heat shrink film.

Still another object of the present disclosure is to provide a process for the preparation of a white, heat shrink film that eliminates the additional step of printing in label preparation.

Yet another object of the present disclosure is to provide a process for the preparation of a white, heat shrink film which completely eliminates the use of white ink.

Other objects and advantages of the present disclosure will be more apparent from the following description, which is not intended to limit the scope of the present disclosure.

### SUMMARY

The present disclosure relates to a white, heat shrink film being a product of a co-polyester; a dye; an optical brightener; an antioxidant; at least one whitening additive and at least one pinning additive. The co-polyester is a reaction product of a dicarboxylic acid, at least three diols, a polymerization catalyst, inorganic particles and a thermal stabilizer.

Further, the present disclosure relates to a process for manufacturing of a white, heat shrink film. The process comprises esterifying predetermined amounts of a dicarboxylic acid and at least three diols at a first predetermined temperature for a first predetermined time period at a first predetermined pressure in an inert atmosphere to obtain an esterified monomer. The esterified monomer is pre-polymerized, at a second predetermined temperature for a second predetermined time period at a second predetermined pressure by using predetermined amounts of inorganic particles, a polymerization catalyst and a thermal stabilizer to obtain a pre-polymer. The pre-polymer is polymerized in an autoclave at a third predetermined temperature for a third predetermined time period at a third predetermined pressure to obtain a co-polyester. The co-polyester is granulated by using an underwater granulator to obtain co-polyester granules having a predetermined size. The co-polyester granules are mixed with predetermined amounts of an antioxidant, an optical brightener, a dye, a pinning additive, a whitening additive to obtain a mixture. The mixture is dried at a fourth predetermined temperature for a fourth predetermined time period to obtain a dried mixture. The dried mixture is extruded by using extruder at a fifth predetermined temperature for a fifth predetermined time period to obtain a polymer melt. The polymer melt is quenched at a sixth predetermined temperature for a sixth predetermined time period to obtain a cast film. The cast film is preheated at a seventh predetermined temperature for a seventh predetermined time period to obtain a mono film. The mono film is stretched in transverse direction at an eighth predetermined temperature for an eighth predetermined time period at a predetermined draw ratio to obtain a transverse oriented film and the transverse oriented film is winded on a winder roll at a temperature in the range of 20° C. to 40° C. to obtain the white, heat shrink film.

In an embodiment of the present disclosure, the co-polyester is present in an amount in the range of 80 mass % to 95 mass %; the dye is present in an amount in the range of 0.0001 mass % to 0.0005 mass %; the optical brightener is present in an amount in the range of 0.03 mass % to 0.09 mass %; the antioxidant is present in an amount in the range of 0.1 mass % to 0.3 mass %; the whitening additive is present in an amount in the range of 4 mass % to 10 mass %; and the pinning additive is present in the range of 0.01 mass % to 0.07 mass %, wherein the mass % of each ingredient is with respect to the total mass of the white, heat shrink film.

In an embodiment of the present disclosure, the dicarboxylic acid is present in an amount in the range of 60 mass % to 75 mass %, the diols are present in an amount in the range of 25 mass % to 40 mass %, the thermal stabilizer is present in an amount in the range of 0.02 mass % to 0.1 mass %, the inorganic particles are present in an amount in the range of 0.02 mass % to 0.06 mass % and the polymerization catalyst is present in an amount in the range of 0.01 mass % to 0.08% mass %, wherein the mass % of each ingredient is with respect to the total mass of the co-polyester.

In an embodiment of the present disclosure, the diols can be selected from the group consisting of ethylene glycol, neopentyl glycol, diethylene glycol, 1,3 propane diol and 1,4 cyclohexane dimethanol.

In an embodiment of the present disclosure, the diols are 65 mole % to 85 mole % of ethylene glycol; 10 mole % to 30 mole % of neopentyl glycol and 1 mole % to 5 mole % of diethylene glycol, wherein the mole % of each component is with respect to the total moles of the diols.

In an embodiment of the present disclosure, the dicarboxylic acid can be selected from the group consisting of terephthalic acid, phthalic acid and isopthalic acid.

In an embodiment of the present disclosure, the inorganic particles can be at least one selected from the group consisting of silica, kaolin, calcium phosphate and calcium carbonate.

In an embodiment of the present disclosure, the polymerization catalyst can be selected from the group consisting of antimony trioxide, antimony triacetate, and germanium dioxide.

The thermal stabilizer can be selected from the group consisting of triphenyl phosphate, and trinonylphenyl phosphate.

In an embodiment of the present disclosure, the dye can be selected from the group consisting of violet dye, red dye, yellow dye and blue dye.

In an embodiment of the present disclosure, the optical brightener can be selected from the group consisting of 2,5-thiophenediylbis(5-tert-butyl-1,3-benzoxazole) and 4,4′-bis(benzoxazol-2-yl)stilbene.

In an embodiment of the present disclosure, the antioxidant is pentaerythritol tetrakis(3-(3,5-di-tert-butyl-4-hydroxyphenyl)propionate).

In an embodiment of the present disclosure, the whitening additive can be selected from the group consisting of titanium dioxide, calcium carbonate and barium sulphate.

In an embodiment of the present disclosure, the pinning additive can be selected from the group consisting of dimethyl sulfo isopthalate sodium salt, manganese acetate (Mn(C₂H₃O₂)₂) and magnesium acetate (Mg(C₂H₃O₂)₂).

In an embodiment of the present disclosure, the white, heat shrink film is characterized by having a thickness in the range of 35 μm to 70 μm; a density in the range of 1.35 g/cm³ to 1.5 g/cm³; a tensile strength in machine direction in the range of 400 Kg/cm² 700 Kg/cm² and a tensile strength in transverse direction in the range of 2000 Kg/cm² to 4000 Kg/cm²; an elongation at break in machine direction in the range of 400% to 700% and an elongation at break in transverse direction in the range of 30% to 100%; an intrinsic viscosity in the range of 0.6 dl/gm to 0.8 dl/gm; a shrinkage ratio in machine direction in the range of 1% @98° C. to 5% @98° C. and a shrinkage ratio in transverse direction in the range of 68% @98° C. to 78% @98° C.; and % transmittance in the range of 20% to 40% at a wavelength in the range of 400 nm to 800 nm and % transmittance below 20% at a wavelength in the range of 200 nm to 400 nm.

In an embodiment of the present disclosure, the first predetermined temperature is in the range of 240° C. to 270° C.; the second predetermined temperature and the third predetermined temperature are independently in the range of 240° C. to 300° C.; the fourth predetermined temperature is in the range of 50° C. to 80° C.; the fifth predetermined temperature is in the range of 230° C. to 280° C.; the sixth predetermined temperature is in the range of 20° C. to 40° C.; the seventh predetermined temperature is in the range of 60° C. to 140° C. and the eighth predetermined temperature is in the range of 60° C. to 140° C.

In an embodiment of the present disclosure, the first predetermined time period, the second predetermined time period and third predetermined time period are independently in the range of 120 minutes to 180 minutes; the fourth predetermined time period is in the range of 200 minutes to 360 minutes; the fifth predetermined time period is in the range of 5 seconds to 30 seconds; the sixth predetermined time period is in the range of 2 seconds to 5 seconds; the seventh predetermined time period is in the range of 5 seconds to 20 seconds and the eighth predetermined time period is in the range of 20 seconds to 50 seconds.

In an embodiment of the present disclosure, the first predetermined pressure is in the range of 0.5 Kg/cm² to 2.5 kg/cm², the second predetermined pressure is in the range of 0.1 mmHg to 0.8 mmHg and the third predetermined pressure is in the range of 0.01 mmHg to 0.2 mmHg. In an embodiment of the present disclosure, the inert atmosphere is nitrogen gas and the underwater granulator is underwater strand granulator.

In an embodiment of the present disclosure, the predetermined size of the co-polyester granules is in the range of 30 Chips/gm to 50 Chips/gm and the predetermined draw ratio is in the range of 3.5 to 5.0.

In an embodiment of the present disclosure, the step of quenching the polymer melt is done on a chill roll by using electrostatic pinning.

### BRIEF DESCRIPTION OF THE ACCOMPANYING DRAWING

The present disclosure will now be described with the help of the accompanying drawing, in which:

FIG. 1 illustrates a flowchart for a process for the manufacturing of a white, heat shrink film in accordance with the present disclosure;

FIG. 2 illustrates a graphical representation for the shrink curve (shrinkage %) at various temperatures of the white, heat shrink film in accordance with the present disclosure; and

FIG. 3 illustrates a graphical representation for the % transmission of the light through the white, heat shrink film in accordance with the present disclosure and the heat shrink film of the comparative example.

### DETAILED DESCRIPTION

The present disclosure relates to a white, heat shrink film and a process of its manufacturing.

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

The heat shrink film plays a vital role in providing labeling, protecting the contents, and improving the product value. Conventionally used heat shrink films are of transparent type and are further required to be printed with white ink to make the film opaque to the light to enhance the shelf life of contents inside the container. The printing of the film with the white ink is an additional operation in the process of manufacturing the heat shrink label/film. Other additional operation such as seaming of the film is also required. Hence, the conventional manufacturing of heat shrink film is accountable for solvent pollution and energy consumption. Further, conventional heat shrink films do not provide an efficient solution for the problems.

The present disclosure provides a white, heat shrink film and a process of its manufacturing. The white, heat shrink film of the present disclosure protects the photosensitive contents present inside the containers such as bottles, boxes and the like that is used to store the ingredients such as medicines, cosmetics, vitamins and the like. Further, the white, heat shrink film of the present disclosure has enhanced seaming and printing properties.

In a first aspect, the present disclosure provides a white, heat shrink film.

In accordance with the present disclosure, the white, heat shrink film is a product of
a. a co-polyester;
b. a dye;
c. an optical brightener;
d. an antioxidant;
e. at least one whitening additive; and
f. at least one pinning additive,
   wherein the co-polyester is a reaction product of a dicarboxylic acid, at least three diols, inorganic particle, a polymerization catalyst and a thermal stabilizer.

In accordance with an embodiment of the present disclosure, the co-polyester is present in an amount in the range of 80 mass % to 95 mass %; the dye is present in an amount in the range of 0.0001 mass % to 0.0005 mass %; the optical brightener is present in an amount in the range of 0.03 mass % to 0.09 mass %; the antioxidant is present in an amount in the range of 0.1 mass % to 0.3 mass %; the whitening additive is present in an amount in the range of 4 mass % to 10 mass %; and the pinning additive is present in the range of 0.01 mass % to 0.07 mass %, wherein the mass % of each ingredient is with respect to the total mass of the white, heat shrink film.

In an embodiment of the present disclosure, the dicarboxylic acid is present in an amount in the range of 60 mass % to 75 mass %; the diols are present in an amount in the range of 25 mass % to 40 mass %; the thermal stabilizer is present in an amount in the range of 0.02 mass % to 0.1 mass %; the inorganic particles are present in an amount in the range of 0.02 mass % to 0.06 mass %; and the polymerization catalyst is present in an amount in the range of 0.01 mass % to 0.08% mass %, wherein the mass % of each ingredient is with respect to the total mass of the co-polyester.

In accordance with the embodiment of the present disclosure, the dicarboxylic acid can be selected from the group consisting of terephthalic acid, phthalic acid and isopthalic acid. In an exemplary embodiment of the present disclosure, the dicarboxylic acid is terephthalic acid.

In an exemplary embodiment of the present disclosure, the amount of the dicarboxylic acid is 66 mass % with respect to the total mass of the co-polyester.

The diols can be selected from the group consisting of ethylene glycol, neopentyl glycol, diethylene glycol, 1,3 propane diol and 1,4 cyclohexane dimethanol.

In an embodiment of the present disclosure, the diols are:
65 mole % to 85 mole % of ethylene glycol;
10 mole % to 30 mole % of neopentyl glycol; and
1 mole % to 5 mole % of diethylene glycol,
   wherein the mole % of each component is with respect to the total moles of the diols. In an exemplary embodiment of the present disclosure, the diol is a combination of ethylene glycol, neopentyl glycol and diethylene glycol in an amount of 75 mole %, 22 mole % and 3 mole %, respectively with respect to the total moles of the diols.

In accordance with the present disclosure, the inorganic particles can be selected from the group consisting of silica, kaolin, calcium phosphate and calcium carbonate. In an exemplary embodiment of the present disclosure, the inorganic particles are silica and the amount of the inorganic particles is 0.045 mass % with respect to the total mass of the co-polyester.

In accordance with the present disclosure, the polymerization catalyst can be selected from the group consisting of antimony trioxide, antimony triacetate, and germanium dioxide. In an exemplary embodiment of the present disclosure, the polymerization catalyst is antimony trioxide and the amount of the polymerization catalyst is 0.045 mass % with respect to the total mass of the co-polyester.

The thermal stabilizer can be selected from the group consisting of triphenyl phosphate and trinonylphenyl phosphate. In an exemplary embodiment of the present disclosure, the thermal stabilizer is triphenyl phosphate.

In an exemplary embodiment of the present disclosure, the amount of the thermal stabilizer is 0.09 mass % with respect to the total mass of the co-polyester.

In accordance with the present disclosure, the dye can be selected from the group consisting of violet dye, red dye, yellow dye and blue dye. In another embodiment of the present disclosure, the violet dye is a mixture of solvaperm REDG (Perinone dyestuff) and solvaperm BLUE-2B (Anthraquinone dyestuff). In an exemplary embodiment of the present disclosure, the dye is violet dye and the amount of dye is 0.0003 mass % with respect to the total mass of the white, heat shrink film.

In accordance with the present disclosure, the optical brightener can be selected from the group consisting of 2,5-thiophenediylbis(5-tert-butyl-1,3-benzoxazole) (Uvitex OB) and 4,4′-bis(benzoxazol-2-yl)stilbene (Uvitex OB-ONE). In an exemplary embodiment of the present disclosure, the optical brightener is 4,4′-bis(benzoxazol-2-yl)stilbene (Uvitex OB-ONE) and the amount of the optical brightener is 0.06 mass % with respect to the total mass of the white, heat shrink film.

In accordance with the present disclosure, the antioxidant is pentaerythritol tetrakis(3-(3,5-di-tert-butyl-4-hydroxyphenyl)propionate) (Irganox 1010). In an exemplary embodiment of the present disclosure, the amount of the antioxidant is 0.15 mass % with respect to the total mass of the white, heat shrink film.

In accordance with the present disclosure, the whitening additive can be selected from the group consisting of titanium dioxide, calcium carbonate and barium sulphate. In an exemplary embodiment of the present disclosure, the whitening additive is titanium dioxide and the amount of the whitening additive is 8 mass % with respect to the total mass of the white, heat shrink film.

In accordance with the present disclosure, the pinning additive can be selected from the group consisting of dimethyl sulfo isopthalate sodium salt, manganese acetate (Mn(C₂H₃O₂)₂) and magnesium acetate (Mg(C₂H₃O₂)₂). In an exemplary embodiment of the present disclosure, the pinning additive is dimethyl sulfo isopthalate sodium salt and the amount of the pinning additive is 0.04% mass % with respect to the total mass of the white, heat shrink film.

The white, heat shrink film of the present disclosure is opaque to the light and hence, enhances the shelf life of photosensitive contents of the container. The white, heat shrink film of the present disclosure can be used for covering, binding or casing of boxes, bottles, sheets, rods, notes, vessels, plastic bottles, glass bottles and various rod-shaped molded parts, particularly used to cover a cap, body and shoulder of such articles. There is no need to print the film with white ink as the white, heat shrink film of the present disclosure is already white in color which provides protection to the photosensitive contents present inside the containers.

In a second aspect, the present disclosure provides a process for manufacturing a white, heat shrink film. The process comprises the following steps:
a. esterifying predetermined amounts of a dicarboxylic acid and at least three diols at a first predetermined temperature for a first predetermined time period at a first predetermined pressure in an inert atmosphere to obtain an esterified monomer;
b. pre-polymerizing the esterified monomer, at a second predetermined temperature for a second predetermined time period at a second predetermined pressure by using predetermined amounts of inorganic particles, a polymerization catalyst and a thermal stabilizer to obtain a pre-polymer;
c. polymerizing the pre-polymer in an autoclave at a third predetermined temperature for a third predetermined time period at a third predetermined pressure to obtain a co-polyester;
d. granulating the co-polyester by using an underwater granulator to obtain co-polyester granules having a predetermined size;
e. mixing the co-polyester granules with predetermined amounts of an antioxidant, an optical brightener, a dye, a pinning additive, a whitening additive to obtain a mixture;
f. drying the mixture at a fourth predetermined temperature for a fourth predetermined time period to obtain a dried mixture;
g. extruding the dried mixture by using extruder at a fifth predetermined temperature for a fifth predetermined time period to obtain a polymer melt;
h. quenching the polymer melt at a sixth predetermined temperature for a sixth predetermined time period to obtain a cast film;
i. preheating the cast film at a seventh predetermined temperature for a seventh predetermined time period to obtain a mono film;
j. stretching the mono film in transverse direction at an eighth predetermined temperature for an eighth predetermined time period at a predetermined draw ratio to obtain a transverse oriented film; and
k. winding the transverse oriented film on a winder roll at a temperature in the range of 20° C. to 40° C. to obtain the white, heat shrink film.

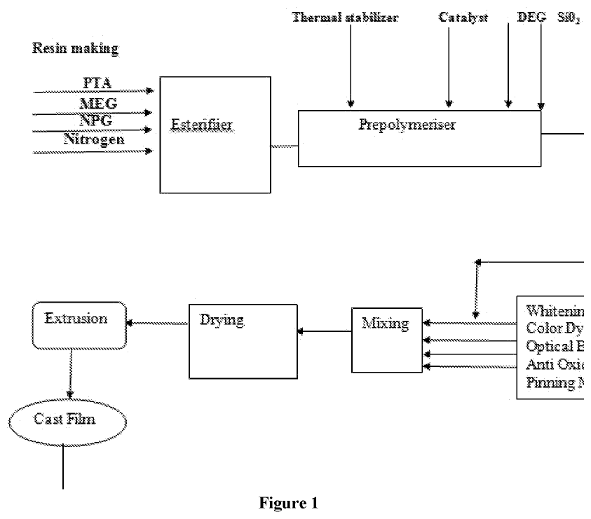

The process is described in detail herein below. FIG. 1 illustrates a flowchart for the process for manufacturing of a white, heat shrink film in accordance with the present disclosure.

In a first step, the predetermined amounts of a dicarboxylic acid and at least three diols are esterified at a first predetermined temperature for a first predetermined time period at a first predetermined pressure in an inert atmosphere to obtain an esterified monomer.

In accordance with the present disclosure, the esterified monomer is bishydroxyl terephthalate (BHET).

In a second step, the esterified monomer is pre-polymerized at a second predetermined temperature for a second predetermined time period at a second predetermined pressure by using predetermined amounts of inorganic particles, a polymerization catalyst and a thermal stabilizer to obtain a pre-polymer.

In a third step, the pre-polymer is polymerized in an autoclave at a third predetermined temperature for a third predetermined time period at a third predetermined pressure to obtain a co-polyester.

In accordance with the present disclosure, the dicarboxylic acid can be selected from the group consisting of terephthalic acid, isopthalic acid and pthalic acid. In an exemplary embodiment of the present disclosure, the dicarboxylic acid is terephthalic acid.

The dicarboxylic acid component is present in an amount in the range of 60 mass % to 75 mass % with respect to the total mass of the co-polyester. In an exemplary embodiment of the present disclosure, the amount of the dicarboxylic acid is 66 mass % with respect to the total mass of the co-polyester.

The diols are selected from the group consisting of ethylene glycol, neopentyl glycol, diethylene glycol, 1,3 propane diol and 1,4 cyclohexane dimethanol. In an exemplary embodiment of the present disclosure, the diols are a combination of ethylene glycol, neopentyl glycol, and diethylene glycol.

In an embodiment of the present disclosure, the diols are a combination of:
65 mole % to 85 mole % of ethylene glycol;
10 mole % to 30 mole % of neopentyl glycol; and
1 mole % to 5 mole % of diethylene glycol,
   wherein the total mole % of each diol is with respect to the total moles of diols.

In an embodiment of the present disclosure, the predetermined amount of the diols is in the range of 25 mass % to 40 mass % with respect to the total mass of the co-polyester. In an exemplary embodiment of the present disclosure, the predetermined amount of the diols is 33.72 mass % with respect to the total mass of the co-polyester.

In accordance with the present disclosure, the first predetermined temperature is in the range of 240° C. to 270° C. In an exemplary embodiment, the first predetermined temperature is 260° C.

In accordance with the present disclosure, the first predetermined time period is in the range of 120 minutes to 180 minutes. In an exemplary embodiment, the first predetermined time period is 150 minutes.

In an embodiment of the present disclosure, the first predetermined pressure is in the range of 0.5 Kg/cm² to 2.5 kg/cm². In an exemplary embodiment, the first predetermined pressure is 1.5 Kg/cm².

In accordance with the present disclosure, the esterified monomer is bishydroxyl terephthalate (BHET).

The inorganic particles can be at least one selected from the group consisting of silica, kaolin, calcium phosphate and calcium carbonate. In an exemplary embodiment of the present disclosure, the inorganic particles are silica particles.

The predetermined amount of the inorganic particles is in the range of 0.02 mass % to 0.06 mass % with respect to the total mass of the co-polyester. In an exemplary embodiment of the present disclosure, the predetermined amount of the inorganic particles is 0.045 mass % with respect to the total mass of the co-polyester.

The polymerization catalyst can be selected from the group consisting of antimony trioxide, antimony triacetate and germanium dioxide. In an exemplary embodiment of the present disclosure, the polymerization catalyst is antimony trioxide.

In an embodiment of the present disclosure, the polymerization catalyst can be dissolved in glycol at 140° C. The glycol can be selected from monoethylene glycol (MEG), diethylene glycol (DEG) and propylene glycol (PEG).

The predetermined amount of the polymerization catalyst is in the range of 0.01 mass % to 0.08 mass % with respect to the total mass of the co-polyester. In an exemplary embodiment of the present disclosure, the predetermined amount of the polymerization catalyst is 0.045 mass % with respect to the total mass of the co-polyester.

The thermal stabilizer can be selected from the group consisting of triphenyl phosphate and trinonylphenyl phosphate. In an exemplary embodiment of the present disclosure, the thermal stabilizer is triphenyl phosphate.

The predetermined amount of the thermal stabilizer is in the range of 0.02 mass % to 0.1 mass % with respect to the total mass of the co-polyester. In an exemplary embodiment of the present disclosure, the predetermined amount of the thermal stabilizer is 0.09 mass % with respect to the total mass of the co-polyester.

In accordance with the present disclosure, the second predetermined temperature is in the range of 240° C. to 300° C. In an exemplary embodiment, the second predetermined temperature is 280° C.

In accordance with the present disclosure, the second predetermined time period is in the range of 120 minutes to 180 minutes. In an exemplary embodiment, the second predetermined time period is 150 minutes.

In accordance with the present disclosure, the second predetermined pressure is in the range of 0.1 mmHg to 0.8 mmHg. In an exemplary embodiment of the present disclosure, the second predetermined pressure is 0.5 mmHg.

In accordance with the present disclosure, the third predetermined temperature is in the range of 240° C. to 300° C. In an exemplary embodiment of the present disclosure, the third predetermined temperature is 285° C.

In accordance with the present disclosure, the third predetermined time period is in the range of 120 minutes to 180 minutes. In an exemplary embodiment of the present disclosure, the third predetermined time period is 150 minutes.

In accordance with the present disclosure, the third predetermined pressure is in the range of 0.01 mmHg to 0.2 mmHg. In an exemplary embodiment of the present disclosure, the third predetermined pressure is 0.1 mmHg.

After the desired degree of polymerization is achieved, the co-polyester is taken out from the autoclave to process further.

In a fourth step, the co-polyester is granulated by using an underwater granulator to obtain co-polyester granules having a predetermined size.

In accordance with the present disclosure, the underwater granulator is underwater strand granulator.

In accordance with the present disclosure, the so obtained granules are in the form of chips and the predetermined size of the granules is in the range of 30 chips/gm to 50 chips/gm. In an exemplary embodiment of the present disclosure, the predetermined size of the co-polyester granules is 40 chips/gm.

In a fifth step, the co-polyester granules are mixed with predetermined amounts of an antioxidant, an optical brightener, a dye, a pinning additive and a whitening additive under stirring to obtain a mixture.

In accordance with the present disclosure, the antioxidant is pentaerythritol tetrakis(3-(3,5-di-tert-butyl-4-hydroxyphenyl)propionate) (Irganox 1010).

The predetermined amount of the antioxidant is in the range of 0.1 mass % to 0.3 mass % with respect to the total mass of the white, heat shrink film. In an exemplary embodiment of the present disclosure, the predetermined amount of the antioxidant is 0.15 mass % with respect to the total mass of the white, heat shrink film.

In accordance with the present disclosure, the optical brightener is selected from the group consisting of 2,5-thiophenediylbis(5-tert-butyl-1,3-benzoxazole) (Uvitex OB) and 4,4′-bis(benzoxazol-2-yl)stilbene (Uvitex OB-ONE). In an exemplary embodiment of the present disclosure, the optical brightener is 4,4′-bis(benzoxazol-2-yl)stilbene (Uvitex OB-ONE).

The predetermined amount of the optical brightener is in the range of 0.03 mass % to 0.09 mass % with respect to the total mass of the white, heat shrink film. In an exemplary embodiment of the present disclosure, the predetermined amount of the optical brightener is 0.06 mass % with respect to the total mass of the white, heat shrink film.

In accordance with the present disclosure, the dye can be selected from the group consisting of violet dye, red dye, yellow dye and blue dye. In an embodiment of the present disclosure, the violet dye is a mixture of solvaperm REDG (Perinone dyestuff) and solvaperm BLUE-2B (Anthraquinone dyestuff). In an exemplary embodiment of the present disclosure, the dye is violet dye.

The predetermined amount of the dye is in the range of 0.0001 mass % to 0.0005 mass % with respect to the total mass of the white, heat shrink film. In an exemplary embodiment of the present disclosure, the predetermined amount of the dye is 0.0003 mass % with respect to the total mass of the white, heat shrink film.

In accordance with the present disclosure, the pinning additive is selected from the group consisting of dimethyl sulfo isopthalate sodium salt, manganese acetate and magnesium acetate. In an exemplary embodiment of the present disclosure, the pinning additive is dimethyl sulfo isopthalate sodium salt.

In accordance with the present disclosure, the predetermined amount of the pinning additive is in the range of 0.01 mass % to 0.07 mass %. In an exemplary embodiment of the present disclosure, the predetermined amount of the pinning additive is 0.04% mass % with respect to the total mass of the white, heat shrink film.

In accordance with the present disclosure, the whitening additive is selected from the group consisting of titanium dioxide, calcium carbonate and barium sulphate. In an exemplary embodiment of the present disclosure, the whitening additive is titanium dioxide.

The predetermined amount of the whitening additive is in the range of 4 mass % to 10 mass % with respect to the total mass of the white, heat shrink film. In an exemplary embodiment of the present disclosure, the predetermined amount of the whitening additive is 8 mass % with respect to the total mass of the white, heat shrink film.

The addition of whitening additive (titanium dioxide) in the manufacturing of the white, heat shrink film enables reduction in light transmission. Therefore, the additional step of white ink printing (usually done in the conventional processes) is eliminated for the protection of photosensitive contents inside the container.

The amount of whitening additive in the range of 4 mass % to 10 mass % is crucial as the addition of whitening additive (titanium dioxide) increase % haze which results in less transmission of light through the white, heat shrink film which is desirable for the protection of photosensitive contents inside the container. If the whitening additive is added less than 4 mass % or more than 10 mass %, then the desired properties are not obtained.

In a sixth step, the mixture of copolyester granules with the antioxidant, the optical brightener, the dye, the pinning additive and the whitening additive are dried at a fourth predetermined temperature for a fourth predetermined time period to obtain a dried mixture.

In accordance with the present disclosure, the fourth predetermined temperature is in the range of 50° C. to 80° C. In an exemplary embodiment, the fourth predetermined temperature is in the range 60° C.

In accordance with the present disclosure, the fourth predetermined time period is in the range of 200 minutes to 360 minutes. In an exemplary embodiment, the fourth predetermined time period is 240 minutes.

In a seventh step, the dried mixture is extruded by using an extruder at a fifth predetermined temperature for a fifth predetermined time period to obtain a polymer melt.

In accordance with the present disclosure, the fifth predetermined temperature is in the range of 230° C. to 280° C. In an exemplary embodiment, the fifth predetermined temperature is 265° C.

In accordance with the present disclosure, the fifth predetermined time period is in the range of 5 seconds to 30 seconds. In an exemplary embodiment, the fifth predetermined time period is 20 seconds.

In an eighth step, the so obtained polymer melt is quenched at a sixth predetermined temperature for a sixth predetermined time period to obtain a cast film.

In accordance with the present disclosure, the sixth predetermined temperature is in the range of 20° C. to 40° C. In an exemplary embodiment, the sixth predetermined temperature is 25° C.

In accordance with the present disclosure, the sixth predetermined time period is in the range of 2 seconds to 5 seconds. In an exemplary embodiment, the sixth predetermined time period is 3 seconds.

In an embodiment of the present disclosure, the polymer melt is quenched on a chill roll by using electrostatic pinning.

In an ninth step, the so obtained cast film is preheated at a seventh predetermined temperature for a seventh predetermined time period to obtain a mono film.

In accordance with the present disclosure, the seventh predetermined temperature is in the range of 60° C. to 140° C. In an exemplary embodiment, the seventh predetermined temperature is 65° C.

In accordance with the present disclosure, the seventh predetermined time period is in the range of 5 seconds to 20 seconds. In an exemplary embodiment, the seventh predetermined time period is 10 seconds.

In a tenth step, the so obtained mono film is stretched in transverse direction at an eighth predetermined temperature for an eighth predetermined time period at a predetermined draw ratio to obtain a transverse oriented film.

In accordance with the present disclosure, the predetermined draw ratio is in the range of 3.5 to 5 times during passing through the transverse direction oven. In an exemplary embodiment, the predetermined draw ratio is 4.5.

In accordance with the present disclosure, the eighth predetermined temperature is in the range of 60° C. to 140° C. In an exemplary embodiment, the eighth predetermined temperature is 100° C.

In accordance with the present disclosure, the eighth predetermined time period is in the range of 20 seconds to 50 seconds. In an exemplary embodiment, the eighth predetermined time period is 30 seconds.

Finally, the so obtained transverse oriented film is winded on a winder roll at a temperature in the range of 20° C. to 40° C. to obtain the white, heat shrink film.

In an embodiment of the present disclosure, the winder roll is kept as jumbo roll. In an exemplary embodiment of the present disclosure, the winder roll is maintained at 25° C.

In another embodiment of the present disclosure, the winder roll is subjected to the slitting to obtain slit rolls. The slit rolls are maintained at a temperature in the range of 20° C. to 40° C.

In an embodiment of the present disclosure, the slitted rolls are packed and stored into separate storage area which is maintained at a temperature in the range of 20° C. to 40° C.

In an embodiment of the present disclosure, the co-polyester is prepared in three reactor batch system. The three reactor batch system comprises an esterifier, a prepolymerizer and an autoclave. By using this system, the time required to complete the process is comparatively less.

The process for manufacturing of the white, heat shrink film in accordance with the present disclosure is simple, economic and is convenient for industrial scale-up.

The white, heat shrink film manufactured in accordance with the present disclosure has a thickness in the range of 35 μm to 70 μm; a density in the range of 1.35 g/cm³ to 1.5 g/cm³; a tensile strength in machine direction in the range of 400 Kg/cm² 700 Kg/cm² and a tensile strength in transverse direction in the range of 2000 Kg/cm² to 4000 Kg/cm²; an elongation at break in machine direction in the range of 400% to 700% and an elongation at break in transverse direction in the range of 30% to 100%; an intrinsic viscosity in the range of 0.6 dl/gm to 0.8 dl/gm; a shrinkage ratio in machine direction in the range of 1% @98° C. to 5% @98° C. and a shrinkage ratio in transverse direction in the range of 68% @98° C. to 78% @98° C.; and % transmittance in the range of 20% to 40% at a wavelength in the range of 400 nm to 800 nm and % transmittance below 20% at a wavelength in the range of 200 nm to 400 nm.

The white, heat shrink film of the present disclosure can be used in packaging, multi-packaging, covering, binding or casing of various articles to enhance the shelf life of the contents inside the container. The white, heat shrink film of the present disclosure is cost-effective, blocks UV light and thus, protects the photosensitive contents and enhances shelf life of the contents in a container.

The process of the present disclosure is simple, economic and eliminates printing step for white ink printing and thereby eliminates the solvent pollution. The process of the present disclosure also helps to improve the mechanical properties of the heat shrinkable film and enhances the storage life of the shrink label due to the elimination of printing step for white ink thereby eliminating the use of solvent. The elimination of solvent/printing step is crucial due to fact that the traces of solvents that are used during white ink printing are responsible for degradation of heat shrink film. Further, the process of the present disclosure is energy saving as the printing activity is eliminated. In addition, the process of the present disclosure reduces time for production and enhances the productivity.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purposes only and not to be construed for limiting the scope of the disclosure. The following experiments can be scaled up to industrial/commercial scale and the results obtained can be extrapolated to industrial scale.

### EXPERIMENTAL DETAILS

### Experiment 1: Process for the Preparation of the White, Heat Shrink Film in Accordance with the Present Disclosure

### Example 1

Co-polyester was prepared in three Reactor batch system comprising an esterifier, a prepolymerizer, and an autoclave. All these reactors were heated upto 320° C. as per the system requirement. The esterifier was operated at 1.5 kg/cm² pressure, the pre-polymerizer was operated at 0.5 mmHg and autoclave was operated at 0.1 mmHg. Individual systems were equipped with overhead condensers for vapor cooling. All contact parts of the reactors and accessories were of stainless steel. The reactors were equipped with unique design of agitators and heating and cooling systems.

100 mole % of terephthalic acid (total carboxylic acid), 76 mole % of ethylene glycol, 22 mole % of neopentyl glycol and 2 mole % of diethylene glycol (total diol content) were charged in an esterifier (equipped with a stirrer, a condenser, a fractionating column, a filter, and a nitrogen gas inlet) at 260° C. for 150 minutes to obtain bishydroxyl terephthalate (BHET) (an esterified monomer). The so obtained monomer was filtered prior to polymerization step.

Following mass % of the ingredients were used to obtain the co-polyester. The mass % of the ingredients were with respect to the total mass % of the co-polyester.

Separately, 450 ppm (0.045 mass %) (Polymer basis) antimony trioxide (polymerization catalyst) was dissolved in 2% concentration of ethylene glycol at 140° C. to obtain a catalyst solution. The so obtained catalyst solution, 900 ppm (0.09 mass %) of triphenyl phosphate (thermal stabilizer) and 450 ppm (0.045 mass %) of silica (inorganic particles) were added into BHET (esterified monomer) to obtain a resultant mass of BHET. The pre-polymerization of BHET was carried in a pre-polymerizer at 280° C. for 150 minutes to obtain a prepolymer. The so obtained prepolymer was transferred to an autoclave and was further polymerized at 285° C. for 150 minutes at 0.1 mmHg pressure to obtain a co-polyester.

The co-polyester was granulated by using an underwater granulator to obtain co-polyester granules having particle size of 40 chips/gm.

Following mass % of the ingredients were used to obtain the white, heat shrink film wherein the mass % of the ingredients were with respect to the total mass % of the white, heat shrink film.

The so obtained co-polyester granules were mixed with 8 mass % of titanium dioxide (whitening additive), 0.0003 mass % of violet dye (dye), 0.06 mass % of 4,4′-bis(benzoxazol-2-yl)stilbene (Uvitex OB 1) (optical brightener), 0.15 mass % pentaerythritol tetrakis(3,5-di-tert-butyl-4-hydroxyphenyl)propionate) (Irganox 1010) (antioxidant) and 0.04 mass % of dimethyl sulfo isopthalate sodium salt (DMSI) (pinning additive) under stirring in the Nautomixer (500 kg batch for 8 minutes) to obtain a mixture.

The so obtained mixture was dried at 60° C. for 240 minutes to obtain a dried mixture.

The dried mixture was extruded at 265° C. for 20 seconds by using extruder to obtain a polymer melt.

The polymer melt was quenched on chill roll by using electrostatic pinning at 25° C. for 3 seconds to obtain a cast film.

The cast film was preheated in a machine direction at temperature between 60° C. to 70° C. (temperature range was given due to use of multiple rollers) for 10 seconds to obtain a mono film.

The mono film was stretched in a transverse direction at temperature between 70° C. to 105° C. (temperature range was given due to use of multiple sections of oven) for 30 seconds at a draw ratio of 4.5 times during passing through the TDO (Transverse direction Oven) to obtain a transverse oriented film.

The so obtained transverse oriented film was winded on a winder roll at 25° C. to obtain the white, heat shrink film.

The white, heat shrink film prepared in accordance with the present disclosure was studied to determine various properties.

% Transmittance of the white, heat shrink film prepared in accordance with the present disclosure was tested as per ASTM D-1003 standard experiment.

% Shrinkage of the white, heat shrink film in machine direction (MD) and in transverse direction (TD) were tested as per Garware Hi-Tech Films Limited (GHFL) method. In the GHFL method, a test sample of 100×100 mm was placed in a water bath maintained at 98° C. for 30 seconds. The change in the dimensions was measured by using following formula:

$$( Change in dimension / original dimension ) * 100 = \% shrinkage in that direction ( MD or TD ) .$$

The properties of the white, heat shrink film are summarized in Table 1 below.

TABLE 1
Properties of the white, heat shrink film of the present disclosure

| Properties | Unit | Value | Method | Remarks |
|---|---|---|---|---|
| Thickness | μm | 40/45/50 | ASTM# E252 | (Tolerance: ±10%) |
| Density | g/cm³ | 1.4 | ASTM#D1505 | (Tolerance: ±0.02 g/cm³) |
| Tensile Strength | | | | |
| Machine Direction | Kg/cm² | 550 | ASTM#D882 | Tolerance ± 150 |
| (MD) | | | | |
| Transverse | Kg/cm² | 3000 | ASTM#D882 | Tolerance ± 300 |
| Direction (TD) | | | | |
| Elongation at break | | | | |
| Machine Direction | % | 500 | ASTM#D882 | Tolerance ± 150 |
| (MD) | | | | |
| Transverse | % | 50 | ASTM#D882 | Tolerance ± 20 |
| Direction (TD) | | | | |
| Shrinkage | | | | |
| Machine Direction | % | <5 | GHFL* | 98° C., 30 sec. in water |
| (MD) | | | | Tolerance: ±3 |
| Transverse | % | 73 | GHFL* | 98° C., 30 sec. in water |
| Direction (TD) | | | | Tolerance: ±3 |
| Transmittance | % | 25 | ASTM#D1003 | Tolerance: ±5 |
| Gloss | 60° C. | 20 | ASTM#D2457 | Gardner value, |
| | | | | Tolerance ± 5 |
| Coefficient of | — | 0.45 | ASTM#D1894 | One side to other |
| friction-COF | | | | side ± 0.15 |
| (Dynamic) | | | | |
| Seaming solvent | Preferred-1,3-dioxolane | | | GHFL method |
| Reel width | mm | | −0.0/+5 mm of required width | |
| tolerance | | | | |

| | |
|---|---|
| Packaging | Individual rolls are wrapped in paper and metalized film and those are |
| (Standard) | pelletized on wooden pallets. There after stretch wrapped, fork-lift- |
| | handling from all sides is possible. |

#Standard for American Society for Testing and Material
*Garware Hi-Tech Films Limited

The properties of the white, heat shrink film summarized in Table 1 were found to be in the desired range.

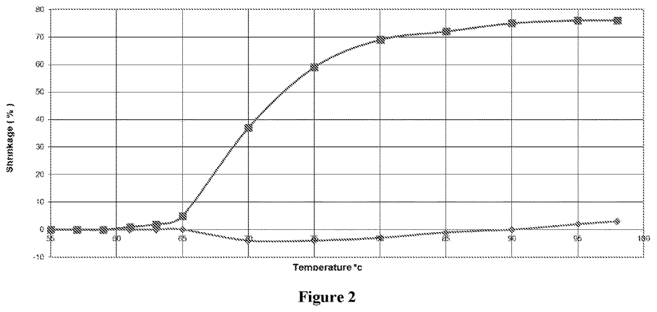

The results of FIG. 2 illustrated that the white, heat shrink film has <5% shrinkage in machine direction when tested at 98° C., for 30 sec. in water whereas 73% shrinkage in transverse direction when tested at 98° C., for 30 sec. in water.

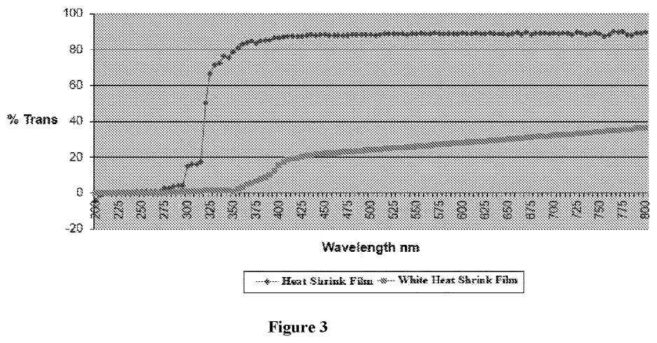

The results of FIG. 3 showed % transmittance below 20% at a wavelength in the range of 200 nm to 400 nm and 20% to 40% transmittance at a wavelength in the range of 400 nm to 800 nm for the white, heat shrink film prepared in accordance with the present disclosure.

### Comparative Example: Process for the Preparation of a Heat Shrink Film without Whitening Additive (Titanium Dioxide)

Comparative heat shrink film was prepared by using all the process steps of Example 1 except the addition of titanium dioxide (whitening additive).

Both the films, the white, heat shrink film (as prepared in Example 1) and of the heat shrink film (as prepared in the comparative example) were further studied for % transmission of the light, % haze as per ASTM-D-1003 standards in the visible range and color values L, a and b as per CIELAB system (International commission on illuminations).

The above properties of the heat shrink film (as prepared in comparative example) were compared with the white, heat shrink film prepared in accordance with the present disclosure which are summarized in Table 2 below.

TABLE 2
Comparison of properties of the white, heat shrink film of the present
disclosure and the heat shrink film of the comparative example

| | Thickness | % Haze | % | Color | Color | Color | Whiteness |
|---|---|---|---|---|---|---|---|
| | of the | ASTM- | Transmission | value | value | value | Index |
| Film | film | D-1003 | ASTM-D-1003 | (L) | (a) | (b) | CIE |
| Comparative | 45 | 7 | 88.6 | 94.769 | −0.03 | 1.09 | Not |
| example-heat | | | | | | | detectable |
| shrink film | | | | | | | |
| Example 1- | 45 | 105 | 32 | 85.23 | −0.824 | −5.577 | 92 |
| white, heat | | | | | | | |
| shrink film | | | | | | | |

The results in Table 2 indicated that the white, heat shrink film of the present disclosure has 105% haze indicating the lower % of transmission of light (32% of transmission in the visible range) whereas the heat shrink film of the comparative example has 7% haze indicating higher % of transmission of light (88% of transmission in the visible range). The color value (L) of 85.23, the color value (a) of −0.824, color value (b) of −5.577 and the whiteness index of 92 indicates the desired aesthetic properties of the white, heat shrink film.

The result of FIG. 3 showed that the % transmission of the light through the white, heat shrink film prepared in accordance with the present disclosure (with whitening additive) is 32% (upto 40%) and the % transmission of the light through the heat shrink film as prepared in comparative example (without whitening additive) is 88.6% indicating that the white heat shrink of the present disclosure blocks the light efficiently.

### TECHNICAL ADVANCEMENTS

The present disclosure described herein above has several technical advantages including, but not limited to, the realization of;
a white, heat shrink film that:
   is cost-effective;
   protects the photosensitive contents inside the container;
   enhances shelf life of the contents inside the container;
   blocks UV light; and
   has attractive aesthetics such as texture and finish; and
process for the preparation of a white, heat shrink film that
   is simple and economic;
   eliminates printing step for white ink printing and thereby eliminates the solvent pollution in the label production;
   is energy saving as the printing activity is eliminated in the label production;
   reduces time for production and enhances productivity in label production; and
   helps to enhance the shelf life of the packed product.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired object or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A white, heat shrink film being a product of:
a. 80 mass % to 95 mass % of a co-polyester;
b. 0.0001 mass % to 0.0005 mass % of a dye;
c. 0.03 mass % to 0.09 mass % of an optical brightener;
d. 0.1 mass % to 0.3 mass % of an antioxidant;
e. 4 mass % to 10 mass % of at least one whitening additive; and
f. 0.01 mass % to 0.07 mass % of at least one pinning additive,
wherein said co-polyester is a reaction product of a dicarboxylic acid, at least three diols, a polymerization catalyst, inorganic particles and a thermal stabilizer, and
wherein said mass % of each ingredient is with respect to the total mass of said white, heat shrink film.

2. (canceled)

3. The white, heat shrink film as claimed in claim 1, wherein
said dicarboxylic acid is present in an amount in the range of 60 mass % to 75 mass %;
said diols are present in an amount in the range of 25 mass % to 40 mass %;
said thermal stabilizer is present in an amount in the range of 0.02 mass % to 0.1 mass %;
said inorganic particles are present in an amount in the range of 0.02 mass % to 0.06 mass %; and
said polymerization catalyst is present in an amount in the range of 0.01 mass % to 0.08% mass %,
wherein the mass % of each ingredient is with respect to the total mass of said co-polyester.

4. The white, heat shrink film as claimed in claim 1, wherein said dicarboxylic acid is selected from the group consisting of terephthalic acid, phthalic acid, and isophthalic acid; and said diols are selected from the group consisting of ethylene glycol, neopentyl glycol, diethylene glycol, 1,3 propane diol and 1,4 cyclohexane dimethanol.

5. The white, heat shrink film as claimed in claim 1, wherein said diols are:
65 mole % to 85 mole % of ethylene glycol;
10 mole % to 30 mole % of neopentyl glycol; and 1
mole % to 5 mole % of diethylene glycol,
wherein said mole % of each diol is with respect to the total moles of said diols.

6. (canceled)

7. The white, heat shrink film as claimed in claim 1, wherein said
inorganic particles are at least one selected from the group consisting of silica, kaolin, calcium phosphate and calcium carbonate,
said polymerization catalyst is selected from the group consisting of antimony trioxide, antimony triacetate and germanium dioxide;
said thermal stabilizer is selected from the group consisting of triphenyl phosphate and trinonylphenyl phosphate; and
said dye is selected from the group consisting of violet dye, red dye, yellow dye and blue dye.

8-10. (canceled)

11. The white, heat shrink film as claimed in claim 1, wherein
said optical brightener is selected from the group consisting of 2,5-thiophenediylbis(5-tert-butyl-1,3-benzoxazole) and 4,4′-bis(benzoxazol-2-yl)stilbene;
said antioxidant is pentaerythritol tetrakis(3-(3,5-di-tert-butyl-4-hydroxyphenyl) propionate);
said whitening additive is selected from the group consisting of titanium dioxide, calcium carbonate and barium sulphate; and
said pinning additive is selected from the group consisting of dimethyl sulfo isophthalate sodium salt, manganese acetate and magnesium acetate.

12-14. (canceled)

15. The white, heat shrink film as claimed in claim 1 is characterized by having:
a thickness in the range of 35 μm to 70 μm;
a density in the range of 1.35 g/cm³ to 1.5 g/cm³;
a tensile strength in machine direction in the range of 400 Kg/cm² 700 Kg/cm² and a tensile strength in transverse direction in the range of 2000 Kg/cm² to 4000 Kg/cm²;
an elongation at break in machine direction in the range of 400% to 700% and an elongation at break in transverse direction in the range of 30% to 100%;
an intrinsic viscosity in the range of 0.6 dl/gm to 0.8 dl/gm;
a shrinkage ratio in machine direction in the range of 1% @98° C. to 5% @98° C. and a shrinkage ratio in transverse direction in the range of 68% @98° C. to 78% @98° C.; and
% transmittance in the range of 20% to 40% at a wavelength in the range of 400 nm to 800 nm and % transmittance below 20% at a wavelength in the range of 200 nm to 400 nm.

16. A process for manufacturing a white, heat shrink film, said process comprising the following steps:
a. esterifying predetermined amounts of a dicarboxylic acid and at least three diols at a first predetermined temperature for a first predetermined time period at a first predetermined pressure in an inert atmosphere to obtain an esterified monomer;
b. pre-polymerizing said esterified monomer at a second predetermined temperature for a second predetermined time period at a second predetermined pressure by using predetermined amounts of inorganic particles, a polymerization catalyst and a thermal stabilizer to obtain a pre-polymer;
c. polymerizing said pre-polymer in an autoclave at a third predetermined temperature for a third predetermined time period at a third predetermined pressure to obtain a co-polyester;
d. granulating said co-polyester by using an underwater granulator to obtain co-polyester granules having a predetermined size;
e. mixing said co-polyester granules with predetermined amounts of an antioxidant, an optical brightener, a dye, a pinning additive, a whitening additive to obtain a mixture;
f. drying said mixture at a fourth predetermined temperature for a fourth predetermined time period to obtain a dried mixture;
g. extruding said dried mixture by using extruder at a fifth predetermined temperature for a fifth predetermined time period to obtain a polymer melt;
h. quenching said polymer melt at a sixth predetermined temperature for a sixth predetermined time period to obtain a cast film;
i. preheating said cast film at a seventh predetermined temperature for a seventh predetermined time period to obtain a mono film;
j. stretching said mono film in transverse direction at an eighth predetermined temperature for an eighth predetermined time period at a predetermined draw ratio to obtain a transverse oriented film; and
k. winding said transverse oriented film on a winder roll at a temperature in the range of 20° C. to 40° C. to obtain said white, heat shrink film.

17. The process as claimed in claim 16, wherein said inert atmosphere is nitrogen atmosphere and said underwater granulator is underwater strand granulator.

18. The process as claimed in claim 16, wherein said dicarboxylic acid is selected from the group consisting of terephthalic acid, isophthalic acid and phthalic acid; and said diols are selected from the group consisting of ethylene glycol, neopentyl glycol, diethylene glycol, 1,3 propane diol and 1,4 cyclohexane dimethanol.

19. The process as claimed in claim 16, wherein said inorganic particles are selected from the group consisting of silica, kaolin, calcium phosphate and calcium carbonate; said polymerization catalyst is selected from the group consisting of antimony trioxide, antimony triacetate and germanium dioxide; and said thermal stabilizer is selected from the group consisting of triphenyl phosphate and trinonylphenyl phosphate.

20. The process as claimed in claim 16, wherein said whitening additive is selected from the group consisting of titanium dioxide, calcium carbonate and barium sulphate and said pinning additive is selected from the group consisting of dimethyl sulfo isophthalate sodium salt, manganese acetate and magnesium acetate.

21. The process as claimed in claim 16, wherein said dye is selected from the group consisting of violet dye, red dye, yellow dye and blue dye; said optical brightener is selected from the group consisting of 2,5-thiophenediylbis(5-tert-butyl-1,3-benzoxazole) and 4,4′-bis(benzoxazol-2-yl)stilbene; and said antioxidant is pentaerythritol tetrakis(3-(3,5-di-tert-butyl-4-hydroxyphenyl)propionate)

22. The process as claimed in claim 16, wherein said predetermined amounts of:
said dicarboxylic acid is in the range of 60 mass % to 75 mass %;
said diol is in the range of 25 mass % to 40 mass %;
said thermal stabilizer is in the range of 0.02 mass % to 0.1 mass %;
said inorganic particles are in the range of 0.02 mass % to 0.06 mass %; and
said polymerization catalyst is in the range of 0.01 mass % to 0.08% mass %,
wherein the mass % of each ingredient is with respect to the total mass of said co-polyester.

23. The process as claimed in claim 16, wherein said predetermined amounts of:
said optical brightener is in the range of 0.03 mass % to 0.09 mass %;
said dye is in the range of 0.0001 mass % to 0.0005 mass %;
said antioxidant is in the range of 0.1 mass % to 0.3 mass %;
said whitening additive is in the range of 4 mass % to 10 mass %; and
said pinning additive is in the range of 0.01 mass % to 0.07 mass %,
wherein the mass % of each ingredient is with respect to the total mass of said white, heat shrink film.

24. The process as claimed in claim 16, wherein:
said first predetermined temperature is in the range of 240° C. to 270° C.;
said second predetermined temperature and said third predetermined temperature are independently in the range of 240° C. to 300° C.;
said fourth predetermined temperature is in the range of 50° C. to 80° C.;
said fifth predetermined temperature is in the range of 230° C. to 280° C.;
said sixth predetermined temperature is in the range of 20° C. to 40° C.;
said seventh predetermined temperature is in the range of 60° C. to 140° C.; and
said eighth predetermined temperature is in the range of 60° C. to 140° C.

25. The process as claimed in claim 16, wherein:
said first predetermined time period, said second predetermined time period and said third predetermined time period are independently in the range of 120 minutes to 180 minutes;
said fourth predetermined time period is in the range of 200 minutes to 360 minutes;
said fifth predetermined time period is in the range of 5 seconds to 30 seconds;
said sixth predetermined time period is in the range of 2 seconds to 5 seconds;
said seventh predetermined time period is in the range of 5 seconds to 20 seconds; and
said eighth predetermined time period is in the range of 20 seconds to 50 seconds.

26. The process as claimed in claim 16, wherein:
said first predetermined pressure is in the range of 0.5 Kg/cm² to 2.5 kg/cm²;
said second predetermined pressure is in the range of 0.1 mmHg to 0.8 mmHg; and
said third predetermined pressure is in the range of 0.01 mmHg to 0.2 mmHg.

27. The process as claimed in claim 16, wherein said predetermined size of said co-polyester granules is in the range of 30 Chips/gm to 50 Chips/gm and said predetermined draw ratio is in the range of 3.5 to 5.0.

28. The process as claimed in claim 16, wherein said step of quenching said polymer melt is done on a chill roll by using electrostatic pinning.
